(19) United States
(12) Patent Application Publication
(10) Pub. No.: US 2004/0017842 A1
(43) Pub. Date: Jan. 29, 2004

(54) Method of recovering digital signal packet timing

(75) Inventors: Fabien Buda, Paris (FR); Emmanuel Lemois, Paris (FR); Valerie Cueff, Paris (FR); Michael Debbah, Paris (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/096,657

(22) Filed: Mar. 14, 2002

(30) Foreign Application Priority Data
Mar. 15, 2001 (FR) 01 03 528

(51) Int. Cl. H04B 1/707

(52) U.S. Cl. 375/147

(57) ABSTRACT

The invention relates to a method of receiving digital signals sent in the form of packets and modulated, for example phase and/or amplitude modulated, in which method received analog signals are sampled and optimum sampling times are determined individually for each packet. To estimate the optimum sampling time, at least two independent and uncorrelated estimates are effected and said estimates are combined so that the variance of the estimate obtained with the combination is lower than the lowest of the variances of the independent estimates. Accordingly, the quality of the combination is greater than the quality of the best of the estimates.

The invention relates to a method of recovering the timing of digital signal packets.

### BACKGROUND OF THE INVENTION

At present, sending digital signals in the form of packets is a standard technique in telecommunications.

Digital data can be physically transmitted in various ways. The forms of modulation that are routinely used are MPSK phase modulation (M-ary Phase Shift Keying) and QAM phase and amplitude modulation (Quadrature Amplitude Modulation), which use constellations with M states, in which each symbol conveys p bits, where M=2^{p}.

The received analog signal is sampled so that it can be processed digitally. The sampling frequency is necessarily limited by technology and cost constraints. The lower the sampling frequency, the faster the detection processing. Thus a limited number of samples is detected for each symbol, for example four samples for each symbol.

The limited number of samples means that it is essential to synchronize the sampling for each packet in the optimum manner. This synchronization of the sampling for each packet is referred to as sample synchronization or timing recovery. It consists of determining the optimum sampling time for each packet. To this end, a first sampling is carried out and the phase-shift that it is necessary to apply to the sampling frequency to obtain the optimum sampling times is determined.

The sampling frequency must be synchronized to the received packets individually for each packet, because the received packets are generally independent of each other. For example, each area or cell in a telecommunication system is assigned a base station and each terminal sends to the base station; the successive packets received in the base station are generally independent of each other because they come from different terminals.

Note that detecting packets also needs the first symbol of each packet to be identified. This is known as “packet synchronization”, whereas sampling synchronization is known as “timing recovery” or “timing synchronization”, as already mentioned.

Various timing synchronization and packet synchronization algorithms are known in the art. A first type of algorithm is based on determining the timing synchronization and the packet synchronization separately and successively, packet synchronization being effected after timing synchronization. A second type of algorithm determines the optimum sampling time and the start of the packet simultaneously.

### OBJECTS AND SUMMARY OF THE INVENTION

The invention is based on the observation that prior art timing recovery methods do not produce satisfactory results if the packets are short, for example if they contain fewer than 500 symbols, and/or the received signal/noise ratio is relatively low. In some circumstances relatively high error rates are observed with short packets, which is unacceptable in some applications. Furthermore, regardless of the packet length, the person skilled in the art knows that a low signal/noise ratio causes high error rates.

The invention remedies these drawbacks.

In the invention, for timing synchronization of digital packets, especially packets containing fewer than 500 symbols, the optimum sampling time is estimated using at least two different and uncorrelated methods and the estimates are combined so that the variance of the combined estimate is lower than the smallest of the variances obtained with the separate estimates.

In the preferred embodiment of the invention the estimates are combined in a linear fashion and a weighting coefficient is applied to each estimate to minimize the variance of the combination.

In time division multiple access (TDMA) transmission, in which the packets are all of the same kind and all have the same duration, the weighting coefficients depend only on the respective variances of the estimators, and therefore depends only on the signal/noise ratio.

In some cases packet characteristics can vary from one packet to another. In this situation the weighting coefficients can vary from one packet to another. In the case of code division multiple access (CDMA) transmission of packets all containing the same number of symbols, for example, the duration of a packet decreases as the number of stacked codes increases.

In this case a combination of two estimation methods is used, one of which provides good results for packets with a large number of stacked codes and the other of which provides good results for packets with a small number of codes. The weighting coefficients can then vary from one packet to another; the estimate obtained by a method supplying the best result for a small number of codes has the greatest weight in this situation, and the estimate supplying a better result for a large number of codes has a greater weight in the latter situation.

Estimation is preferably effected by block processing, i.e. processing in feedforward mode; the processing is applied to the received samples, delaying them by the processing time.

In one embodiment each packet contains from 100 to 500 symbols.

Briefly, the invention provides a method of receiving digital signals sent in the form of packets and modulated, for example phase and/or amplitude modulated, in which method received analog signals are sampled and the optimum sampling times are determined individually for each packet. In this method, to estimate the optimum sampling time, at least two independent and uncorrelated estimates are effected and combined so that the variance of the estimate obtained with the combination is lower than the smallest of the variances of the independent estimates.

In one embodiment, the estimates are combined in a linear fashion.

The combination is such that a higher weighting coefficient is assigned to the estimate producing the lowest variance, for example.

If the packets are always of the same kind, the combination of the estimates can be the same for all the packets.

If the packets vary in kind from one packet to another, the combination can vary with the nature of the packet.

If the packets are transmitted in accordance with a CDMA transmission technique and the number of codes of a packet is variable, weighting coefficients can be applied to the estimates that depend on the number of codes in each packet.

The number of symbols in each packet is from 100 to 500, for example.

In one embodiment, the estimate is effected in deferred time.

In one embodiment, at least one of the estimates simultaneously estimates an optimum sampling time and determines a start of packet symbol.

The invention applies in particular to the reception by a base station of independent digital data packets from different terminals.

### BRIEF DESCRIPTION OF THE DRAWINGS

Other features and advantages of the invention will become apparent from the description of embodiments of the invention given with reference to the accompanying drawings, in which:

FIG. 1 is a diagram showing two packets, and

FIG. 2 is a diagram showing a result obtained with the invention.

### MORE DETAILED DESCRIPTION

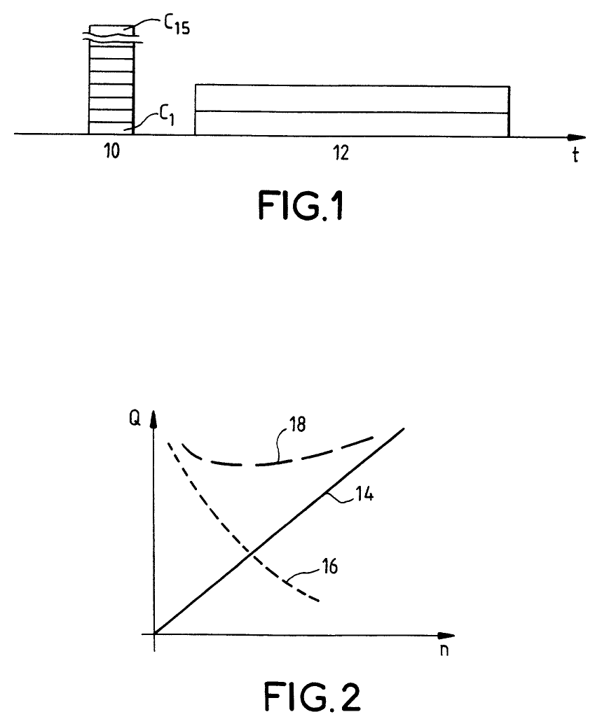

CDMA mode transmission is described first with reference to FIG. 1, in which each packet includes a particular number of symbols, for example 400 symbols. If each symbol has two bits, each packet contains 800 bits. Also, the number of codes can vary from one packet to another. Thus FIG. 1 shows two successive packets 10 and 12, the first packet 10 containing 15 codes and the second packet 12 containing only two codes. The symbols assigned different codes are transmitted simultaneously. Accordingly, a packet 10 containing a large number of codes will be shorter (in time) than a packet 12 containing a small number of codes.

The estimate of the optimum sampling time for such packets obtained with prior art estimation methods does not produce homogeneous results. For example, the MEYR estimation method produces satisfactory results for a relatively high number of codes. On the other hand, for packets with a low number of codes, the estimate obtained has a greater variance. The MEYR estimation method is described in a paper entitled “Digital filter and square timing recovery” by Martin OERDER and Heinrich MEYR published in IEEE Transactions on Communications, Volume 16, No. 5, May 1988, pages 605 to 611.

In a complementary fashion, an unique word algorithm produces satisfactory estimation results for packets of type 12 but less satisfactory results for packets of type 10, with a larger number of codes.

The two estimates are combined by assigning a coefficient to each of the two estimates to obtain an estimate providing better and more homogeneous results than each of the estimation methods taken individually. The coefficients depend on the number of codes. For example, the estimate of the optimum sampling time τ is obtained from the following equation:

$$τ = \frac{{α}_{1} {τ}_{M} + {α}_{2} {τ}_{UW}}{{α}_{1} + {α}_{2}} \qquad ( 1 )$$

In the above equation, τ_{M} represents the estimate obtained with the MEYR method, which is optimized for a large number of codes, τ_{UW} represents the estimate obtained by a method optimized for a small number of codes, and α₁ and α₂ are the weighting coefficients.

For a large number of codes the coefficient α₁ is high and the coefficient α₂ is low and, conversely, for a low number of codes the coefficient α₁ is low and the coefficient α₂ is high.

To determine the coefficients α₁ and α₂ that produce the minimum variance of τ, the following calculation can be used:

Let K be the ratio between the two variances: σ_{M} ² (for τ_{M}) and σ_{UW}² (for τ_{UW}):

$$K = \frac{E ( {τ}_{M}^{2} )}{E ( {τ}_{UW}^{2} )} = \frac{{σ}_{M}^{2}}{{σ}_{UW}^{2}}$$

From equation (1), it can be deduced that:

$$τ = ( \frac{{α}_{1}}{{α}_{1} + {α}_{2}} ) \cdot {τ}_{M} + ( 1 - ( \frac{{α}_{1}}{{α}_{1} + {α}_{2}} ) ) \cdot {τ}_{UW} = α {τ}_{M} + ( 1 - α ) {τ}_{UW}$$

$$whence , where α = \frac{{α}_{1}}{{α}_{1} + {α}_{2}} : \\ {σ}^{2} = {α}^{2} {σ}_{M}^{2} + {( 1 - α )}^{2} {σ}_{UW}^{2} = ( {α}^{2} K + {( 1 - α )}^{2} ) {σ}_{UW}^{2}$$

σ² is the variance of τ.

The derivative of σ² with respect to α is calculated to obtain the minimum value of the variance σ²:

$$\frac{\partial {σ}^{2}}{\partial α} = {σ}_{UW}^{2} ( 2 α K - 2 ( 1 - α ) )$$

This derivative is zero for

$$α = \frac{1}{K + 1} ,$$

i.e.:

$${σ}_{min}^{2} = \frac{K}{K + 1} {σ}_{UW}^{2} = \frac{1}{K + 1} {σ}_{M}^{2}$$

Thus σₘᵢₙ², the variance of τ, is smaller than the smallest of the variances.

Also, it is seen that the above calculation is independent of the algorithms used and the packet type.

If the two estimators have the same variance, the variance resulting from a linear combination of the two variances is half of the variance of each of the original two estimators.

The coefficients α₁ and α₂ are stored in a receiver in the form of a table, for example, i.e. each number of codes is assigned a pair of values α₁ and α₂. The coefficients are determined beforehand empirically or by calculation.

FIG. 2 shows the variation of the quality Q (which is the reciprocal of the variance, for example) of each estimate (vertical axis) as a function of the number n of codes (horizontal axis).

The curve 14 shows the variation in the quality of the estimate for the MEYR algorithm. The curve 16 represents the variation in quality as a function of the number of codes for the unique word algorithm and the curve 18 represents the quality of the combined estimate resulting from equation (1) above. Thus it is seen that the quality of the combined estimate is greater than the individual quality of each estimate.

The invention is not limited to this example. It relates to any type of packet. It also applies to TDMA transmission. In this case the coefficients α₁ and α₂ can be the same for all packets.

As a general rule, it is sufficient for the timing recovery methods used to be different and uncorrelated to obtain an estimate of the optimum sampling time that is better than the better of the two estimates obtained with each of the individual estimates.

It is not essential for the combination to be linear.

The best type of combination is generally determined by calculation, experiment or simulation.

Two or more timing recovery methods can be combined, the only constraint being that they must be uncorrelated. This can apply equally well to estimators which estimate only the timing and to estimators which conjointly estimate the timing and the start of a packet.

The method described by M. MOENCLAEY and T. BATSELE in the paper entitled “Carrier Independent NDA Symbol Synchronization for M-PSK, Operating at only One Sample Per Symbol” published in GLOBECOM'90, pages 155 to 159A is one non-limiting example of an estimation or timing recovery method additional to the MEYR method and the unique word method.

Another example is the estimation method described by K. MUELLER and M. MÜLLER in a paper entitled “Timing Recovery in Digital Synchronous Data Receivers” published in IEEE Trans. Commun. Vol. 24, No. 5, May 1976.

The invention relates not only to an estimation method but also to receivers using the method.

The method according to the invention can be implemented at low cost because the independent and uncorrelated estimation methods used can be methods available off the shelf.

1. A method of receiving digital signals sent in the form of packets and modulated, for example phase and/or amplitude modulated, in which method received analog signals are sampled and the optimum sampling times are determined individually for each packet, wherein, to estimate the optimum sampling time, at least two independent and uncorrelated estimates are effected and combined so that the variance of the estimate obtained with the combination is lower than the smallest of the variances of the independent estimates.

2. A method according to claim 1, wherein the estimates are combined in a linear fashion.

3. A method according to claim 1, wherein the combination is such that a higher weighting coefficient is assigned to the estimate producing the lowest variance.

4. A method according to claim 1, wherein, if the packets are always of the same kind, the combination of the estimates is the same for all the packets.

5. A method according to claim 1, wherein, if the packets vary in kind from one packet to another, the combination varies with the nature of the packet.

6. A method according to claim 5, wherein, if the packets are transmitted in accordance with a CDMA transmission technique and the number of codes of a packet is variable, weighting coefficients are applied to the estimates that depend on the number of codes in each packet.

7. A method according to claim 1, wherein the number of symbols in each packet is from 100 to 500.

8. A method according to claim 1, wherein the estimate is effected in deferred time.

9. A method according to claim 1, wherein at least one of the estimates simultaneously estimates an optimum sampling time and determines a start of packet symbol.

10. An application of the method according to claim 1 to independent digital data packets received by a base station from different terminals.
